(19) United States
(12) Patent Application Publication
(10) Pub. No.: US 2026/0267747 A1
(43) Pub. Date: Sep. 10, 2026

(54) STORAGE MEDIUM AND CONTROL METHOD

(71) Applicant: BUFFALO INC., Tokyo (JP)

(72) Inventors: Daisuke BABA, Aichi (JP); Wataru ONOGI, Aichi (JP); Suguru ISHII, Aichi (JP)

(73) Assignee: BUFFALO INC., Tokyo (JP)

(21) Appl. No.: 19/554,706

(22) Filed: Mar. 3, 2026

(30) Foreign Application Priority Data
Mar. 5, 2025 (JP) 2025-034440

(51) Int. Cl. G06F 11/1446

(52) U.S. Cl. CPC G06F 11/1469; G06F 11/1448

(57) ABSTRACT

A non-transitory computer-readable storage medium stores a control program for causing a processor of an information terminal to execute a process. The process includes: a first backup process including storing one or more files to be backed up in an external storage device communicable with the information terminal, and registering identification information of a successfully stored file in a first list; and a second backup process, which is executed after the first backup process, including storing one or more files to be backed up in the external storage device based on the first list.

### CROSS-REFERENCE TO RELATED APPLICATION

This application is based on and claims priority under 35 USC 119 from Japanese Patent Application No. 2025-034440 filed on Mar. 5, 2025, the contents of which are incorporated herein by reference.

### TECHNICAL FIELD

The present disclosure relates to a storage medium and a control method.

### BACKGROUND

Photograph and video data stored in information terminals such as a smartphone or a tablet may be stored in, for example, a universal serial bus (USB) storage for the purpose of sharing with other terminals or for backing up. However, if the process is interrupted, for example, when the USB storage is removed while backing up or restoring data, the data may be damaged or may not be backed up.

For example, Japanese Patent Application Laid-Open Publication No. 2006-013824 discloses a storage system related to backup. Specifically, when a user mobile terminal accesses an information server via a communication network, the information server receives backup data from the user mobile terminal through a communication unit after the user is authenticated by an authentication unit. The information server determines the data type of the backup data using a data type determination unit, and stores the backup data in an information storage unit in classification based on the user ID and the data type. However, in the related art, there is room for improvement in efficiently backing up content data managed by an information terminal to an external storage.

The present disclosure is made in view of the above circumstances, and relates to a storage medium that stores a control program that allows a file to be backed up to be efficiently stored in an external storage device, and a control method.

### SUMMARY

A storage medium according to a first aspect of the present disclosure is a non-transitory computer-readable storage medium storing a control program for an information terminal. The control program causes a processor of the information terminal to execute a process including: a first backup process including storing one or more files to be backed up in an external storage device capable of communicating with the information terminal, and registering identification information of a successfully stored file in a first list; and a second backup process, which is executed after the first backup process, of storing one or more files to be backed up in the external storage device based on the first list.

A control method according to a second aspect of the present disclosure includes: by a processor of an information terminal, a first backup process including storing a file to be backed up in an external storage device capable of communicating with the information terminal, and registering identification information of a successfully stored file in a first list; and a second backup process, which is executed after the first backup process, of storing a file to be backed up in the external storage device based on the first list.

A storage medium according to a third aspect of the present disclosure is a non-transitory computer-readable storage medium storing a control program for an information terminal. The control program causes a processor of the information terminal to execute a process including: classifying one or more files to be backed up into a file stored in the information terminal and a file stored in an information processing device capable of communicating with the information terminal; and executing a first backup process including storing the file to be backed up in an external storage device capable of communicating with the information terminal in an order based on a result of the classification.

### BRIEF DESCRIPTION OF DRAWINGS

Exemplary embodiment(s) of the present disclosure will be described in detail based on the following figures, wherein:

FIG. 1 is a diagram illustrating an example of a communication system to which an information terminal according to the present disclosure is applied;

FIG. 2 is a diagram illustrating an example of hardware of an information terminal 10;

FIG. 3 is a diagram illustrating a software configuration of the information terminal 10;

FIG. 4 is a flowchart illustrating an example of a process by a backup application 18;

FIG. 5 is a flowchart illustrating a backup process in step S14 and step S15 in FIG. 4;

FIG. 6 is a diagram illustrating an example of a written list;

FIG. 7 is a diagram illustrating a flow of backing up first image data in a communication system 1;

FIG. 8 is a diagram illustrating a flow of backing up second image data in the communication system 1;

FIG. 9 is a diagram illustrating a modification of the communication system 1;

FIG. 10 is a flowchart illustrating an example of a process of the backup application 18 in the modification;

FIG. 11 is a flowchart illustrating a backup process in step S34 in FIG. 10;

FIG. 12 is a diagram illustrating a flow of backing up image data in the communication system 1; and

FIG. 13 is a diagram illustrating an example of a notification prompting deletion of a file.

### DESCRIPTION OF EMBODIMENTS

Hereinafter, embodiments of the present disclosure will be described with reference to the drawings.

### Embodiments

### Communication System to Which Information Terminal is Applied

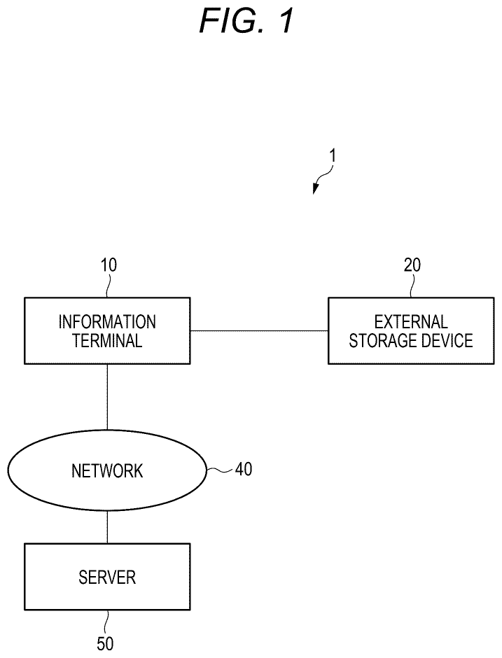

FIG. 1 is a diagram illustrating an example of a communication system to which an information terminal according to the present disclosure is applied. The communication system 1 illustrated in FIG. 1 includes an information terminal 10, an external storage device 20, and a server 50.

The information terminal 10 is, for example, a portable information terminal. A portable information terminal generally refers to an information terminal having a small storage capacity, such as a smartphone or a tablet terminal. Alternatively, the information terminal 10 may be, for example, a notebook personal computer or a desktop personal computer.

The “control program” of the present disclosure causes the information terminal 10 to execute a process of controlling backup of a file managed by the information terminal 10 to the external storage device 20. The control program is, for example, a backup application installed in the information terminal 10.

The “file managed by the information terminal 10” is an example of files to be backed up, and is, for example, an image managed in a photo library (an image that can be viewed with a photo application).

The “file” is content data such as image (still image or moving image) data or audio data. Further, the “file” may include, for example, a first file whose data body (backup target) is stored in the information terminal 10, and, for example, a second file whose data body is stored in the server 50. The data body of the first file may be stored in the server 50, or may not be stored on the server 50. In the second file, the information terminal 10 stores only reduced data (for example, a thumbnail) of the data body. In the photo library, the first file and the second file are managed in a mixed state. The file may be stored in one folder or may be stored in a plurality of folders. The information terminal 10 is communicably connected to the external storage device 20 and the server 50.

The external storage device 20 is a storage device such as a solid state drive (SSD) or a hard disk drive (HDD), and is an example of an “external storage device” of the present disclosure. The external storage device 20 is connected to the information terminal 10 by wire using, for example, a universal serial bus (USB), Lightning, or the like. Further, the external storage device 20 may be one that can communicate wirelessly. For example, the external storage device 20 may be one that can directly communicate with the information terminal 10 using Bluetooth (registered trademark), or may be a network attached storage (NAS) that can be connected to a network (for example, a wireless local area network (LAN)).

The server 50 is communicably connected to the information terminal 10 via the network 40. The network 40 is, for example, a wide area network (WAN). The server 50 is a device that allows the information terminal 10 to store data via the network 40. The server 50 is, for example, a cloud server.

### Configuration of Information Terminal 10

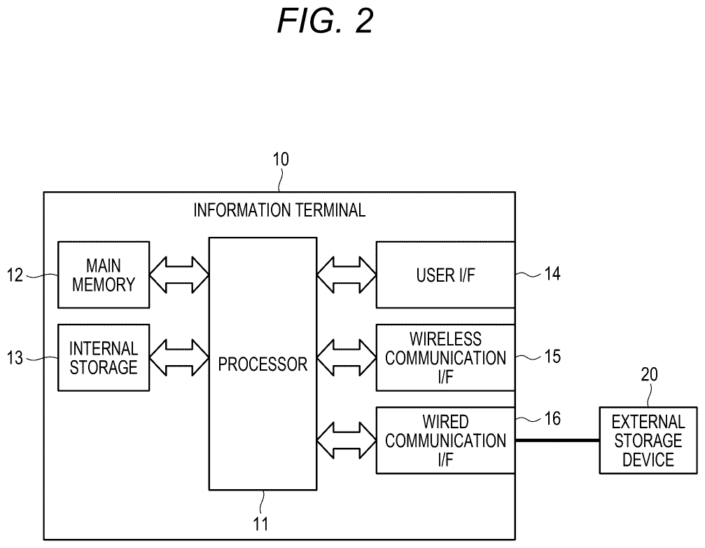

FIG. 2 is a diagram illustrating an example of hardware of the information terminal 10. As illustrated in FIG. 2, the information terminal 10 includes a processor 11, a main memory 12, an internal storage 13, a user interface (I/F) 14, a wireless communication I/F 15, and a wired communication I/F 16.

The processor 11 may be implemented as programmable circuitry that performs signal processing, and may be, for example, a central processing unit (CPU) that controls the entire information terminal 10. Note that the processor 11 may be implemented by other digital circuitry such as a field programmable gate array (FPGA) and a digital signal processor (DSP). The processor 11 may also be implemented by combining a plurality of digital circuits.

The main memory 12 is, for example, a random access memory (RAM). The main memory 12 is used as a work area of the processor 11. The internal storage 13 is a nonvolatile memory such as a magnetic disk, an optical disk, or a flash memory. The internal storage 13 stores various programs (computer readable code) that operate the information terminal 10. The programs stored in the internal storage 13 are loaded into the main memory 12 and executed by the processor 11. The backup application, which is a control program of the present disclosure, is stored in the internal storage 13.

The user I/F 14 is a communication interface that communicates with the processor 11. The user I/F 14 functions as an input device and a display device of the processor 11. The user I/F 14 includes, for example, a display screen (touch panel), a keyboard, and the like, and is configured to input various commands to the processor 11. Further, the user I/F 14 is configured to display various screens related to control details of the processor 11.

The wireless communication I/F 15 is a communication interface that can perform wireless communication with the server 50. For example, the wireless communication I/F 15 may be able to perform wireless communication using frequency bands of 2.4 GHz, 5 GHz, and 6 GHz. The information terminal 10 may be a wireless terminal compatible with wireless communication of a wireless LAN such as Wi-Fi 7 (Wi-Fi is a registered trademark). The wireless communication I/F 15 connects the information terminal 10 to the server 50 via the network 40.

The wired communication I/F 16 is a communication interface that performs wired communication with the external storage device 20. In the example illustrated in FIG. 2, the information terminal 10 is connected to the external storage device 20 in a wired manner, but may be connected thereto in a wireless manner.

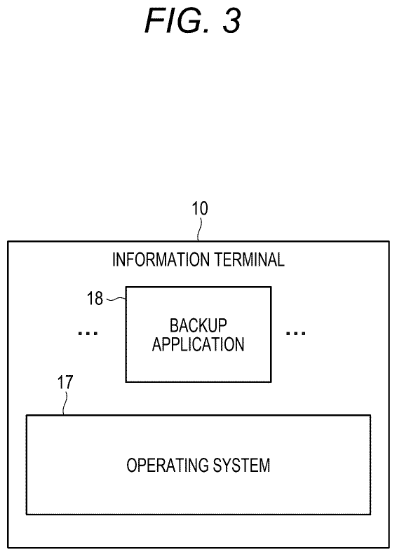

FIG. 3 is a diagram illustrating a software configuration of the information terminal 10. As illustrated in FIG. 3, the information terminal 10 is equipped with an operating system 17 for managing and controlling the overall operation. A plurality of applications including a backup application 18 are installed in the information terminal 10. The backup application 18 is one of the plurality of applications that run on the operating system 17.

The backup application 18 causes the processor 11 to execute a process of storing a file to be backed up in the external storage device 20 that can communicate with the information terminal 10. The backup application 18 causes the processor 11 to execute a first backup process of registering identification information of a successfully stored file in a first list. The backup application 18 causes the processor 11 to execute a process of executing, based on the first list, a second backup process of storing a file to be backed up in the external storage device 20, which is executed after the first backup process.

The “identification information” is information capable of identifying a file, and is, for example, a file name, a file ID, or the like. The “first list” may be stored in the information terminal 10 or may be stored in the external storage device 20. Further, the “first list” may be stored in both the information terminal 10 and the external storage device 20 as a list with the same contents. If the list is stored in both devices, a consistency check may be performed on both lists before the backup process. “Based on the first list” means based on the first list in which the identification information of the successfully stored file is registered.

The “backup process” means requesting a file from the operating system 17, storing the file in a temporary folder assigned to the backup application 18, transmitting the file from the temporary folder to the external storage device 20, and storing the file in the external storage device 20. As the operation of the operating system 17 side, for example, the first file stored in the information terminal 10 is read from the information terminal 10 and sent to the backup application 18. Regarding the second file stored in the server 50, if the second file is in the cache in the information terminal 10, the file is read out and sent to the backup application 18, and if it is not in the cache, the file is received from the server 50 and sent to the backup application 18.

For example, when the backup application 18 successfully stores one file to the external storage device 20 in the first backup process, the backup application 18 causes the processor 11 to execute a process of registering the identification information of the one file in the first list. As a result, even if an application error occurs during backup process, for example, files that have been successfully stored before the error occurs are registered in the first list.

Further, in the first backup process, when the storage of a file to the external storage device 20 fails, the backup application 18 determines whether the cause of the failure is continuous, and if the cause is continuous, causes the processor 11 to execute a process of not executing the storage of the file related to the failure to the external storage device 20. “Not executing the storage” means that storage is not executed at least in the backup process. Continuous causes include, for example, disconnection of the external storage device 20 from the information terminal 10, low battery level of the information terminal 10, insufficient capacity of the external storage device 20, cancellation of backup processing by the user, and the like.

Further, in the first backup process, when the storage of a file to the external storage device 20 fails, the backup application 18 determines whether the cause of the failure is continuous, and if the cause is not continuous, causes the processor 11 to execute a process of re-executing the storage of the file related to the failure to the external storage device 20. “The cause is not continuous” means that, for example, the number of download failures from the cloud (server 50) is less than N times. Therefore, for example, when the number of download failures is N or more times, it is determined that the cause of the failure is continuous. Further, “the cause is not continuous” may be, for example, that the number of write errors in the external storage device 20 is less than N times. In that case, for example, if the write error occurs N or more times, it is determined that the cause of the failure is continuous. Note that if the storage by re-execution is successful, the backup application 18 registers the file in the first list.

The backup application 18 also causes the processor 11 to execute a process of registering, in the first list, identification information of a file successfully stored in the second backup process. The backup application 18 does not create a new list in the second backup process, but registers the identification information of the successfully stored files in the first list taken over from the first backup process, and updates the first list.

In the second backup process, the backup application 18 causes the processor 11 to execute a process of storing, in the external storage device 20, files other than the files registered in the first list among the files managed by the information terminal 10. That is, the backup application 18 does not repeatedly perform the backup process on the files that have already been stored.

In the first backup process, the backup application 18 causes the processor 11 to execute a process of not registering the identification information of the file that has failed to be stored in the first list.

### Process by Backup Application 18

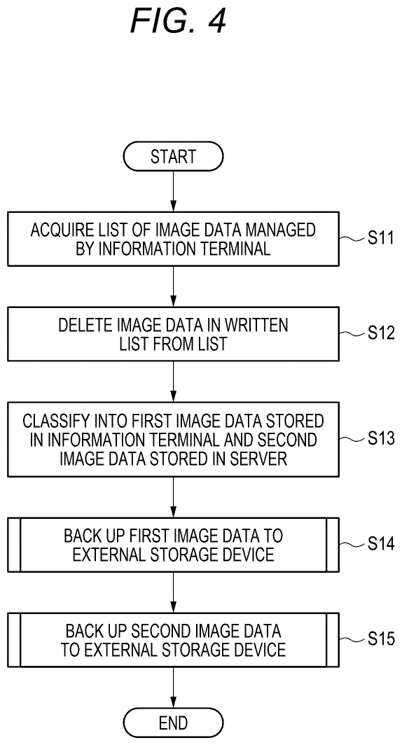

FIG. 4 is a flowchart illustrating an example of a process by the backup application 18. The process of this flowchart is started, for example, when an icon of the backup application 18 displayed on the display screen of the information terminal 10 is tapped. In this example, a case where image data (an example of a file) managed by the information terminal 10 is backed up in the external storage device 20 (external storage device) will be described. The image data includes still image data and moving image data. In this example, first, the image data (hereinafter referred to as first image data) stored in the information terminal 10 is backed up, and then image data (hereinafter referred to as second image data) stored in the server 50 is backed up.

The backup application 18 acquires from the operating system 17 a management list (for example, a list of PHAssets) of image data managed by the information terminal 10 (step S11). The operating system 17 acquires the management list using an application programming interface (API).

The backup application 18 acquires, for example, a backup list in which the image data in a written list indicating files that have already been successfully stored is deleted from the management list of the image data acquired in step S11 (step S12). In the process of step S12, if the backup process is, for example, the first backup process, the files that have been successfully stored have not yet been registered in the written list.

The backup application 18 classifies the image data into the first image data stored in the information terminal 10 and the second image data stored in the server 50 based on the backup list acquired in step S12 (step S13).

The backup application 18 first backs up the first image data out of the classified first image data and second image data to the external storage device 20 (step S14).

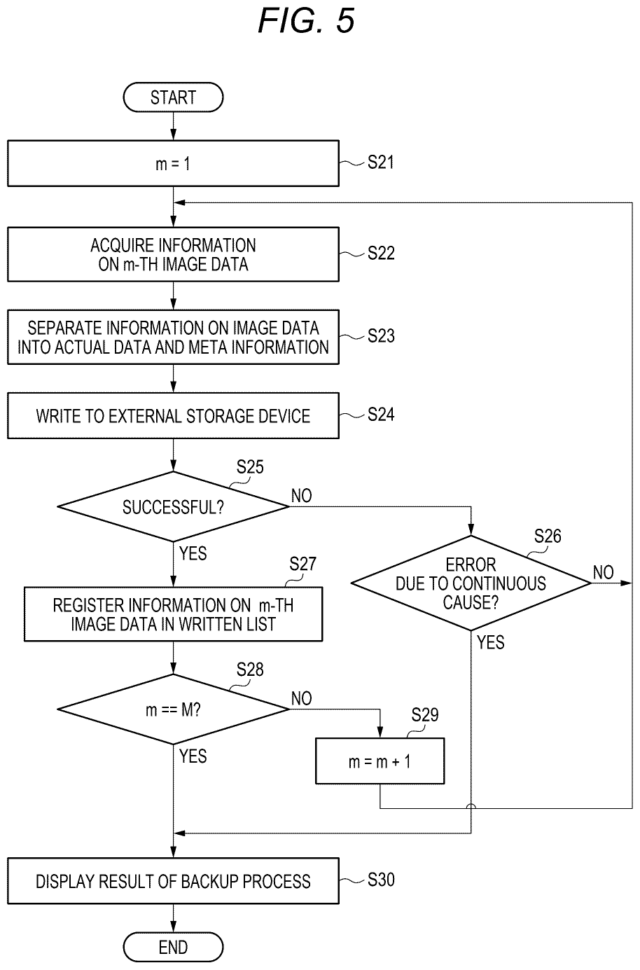

Next, the backup application 18 backs up the second image data out of the classified first image data and second image data to the external storage device 20 (step S15). The backup processes in step S14 and step S15 will be described with reference to FIG. 5.

FIG. 5 is a flowchart illustrating the backup processes in step S14 and step S15 in FIG. 4.

In step S14, when the backup process of the first image data stored in the information terminal 10 is performed, the backup application 18 first sets m=1 (step S21), and acquires information about the m=1st first image data in the backup list acquired in step S12 of FIG. 4 from the internal storage 13 (step S22). The information about the image data includes, for example, an image data body and information related to the data.

Next, the backup application 18 separates the information of the image data acquired in step S22 into actual data and meta information (step S23), and writes the image data to the external storage device 20 (step S24).

The backup application 18 determines whether the image data is successfully stored in the external storage device 20 in step S24 (step S25).

When the storage of the image data fails in step S25 (step S25: No), the backup application 18 determines whether the failure is due to a continuous cause (step S26). The continuous failure is, for example, N or more failures as described above.

If it is determined in step S26 that the failure is not continuous (step S26: No), the backup application 18 returns to step S22 and executes each process. If it is determined that the failure is not continuous, the backup application 18 may wait a predetermined time and then return to step S22. Further, if the failure is an error that does not require returning to step S22 to acquire information on the image data again, the backup application 18 may return to step S24 and execute each process.

If it is determined in step S26 that the failure is continuous (step S26: Yes), the backup application 18 displays the result of the backup process on the display screen of the information terminal 10 (step S30). If the cause of the failure is continuous, the backup application 18 does not store the image data related to the failure, at least not in this backup process.

On the other hand, if the image data is successfully stored in step S25 (step S25: Yes), the backup application 18 registers the information about the m=1st first image data in the written list (step S27).

Next, the backup application 18 determines whether the number (m-th) of pieces of the first image data to be backed up has reached M-th (m=M?) (step S28). The M is the number of pieces of first image data registered in the backup list.

If m=M is not satisfied in step S28 (step S28: No), the backup application 18 sets m=m+1 (step S29) and returns to step S22 to execute each process. If m=M in step S28 (step S28: Yes), that is, when the backup process of the first image data registered in the backup list is completed, the backup application 18 displays the result of the backup process on the display screen of the information terminal 10 (step S30).

When the backup process of the second image data stored in the server 50 is to be performed in step S15 of FIG. 4, the following process is performed.

The backup application 18 sets m=1 (step S21), and acquires information on m=1st second image data in the backup list acquired in step S12 of FIG. 4 by downloading the information from the server 50 (step S22). The process from step S23 onwards is the same as the backup process of the first image data described above.

### Written List

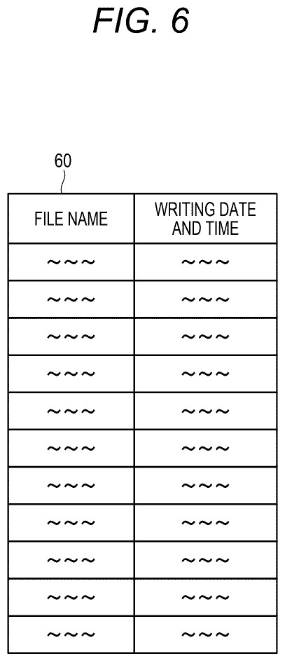

FIG. 6 is a diagram illustrating an example of the written list. As illustrated in FIG. 6, identification information of image data (files) that has been successfully stored in the external storage device 20 is registered in the written list. For example, the written list 60 includes “file name” and “writing date and time” as attribute information of the image data. The written list 60 is an example of the “first list” of the present disclosure.

### Backup of Image Data

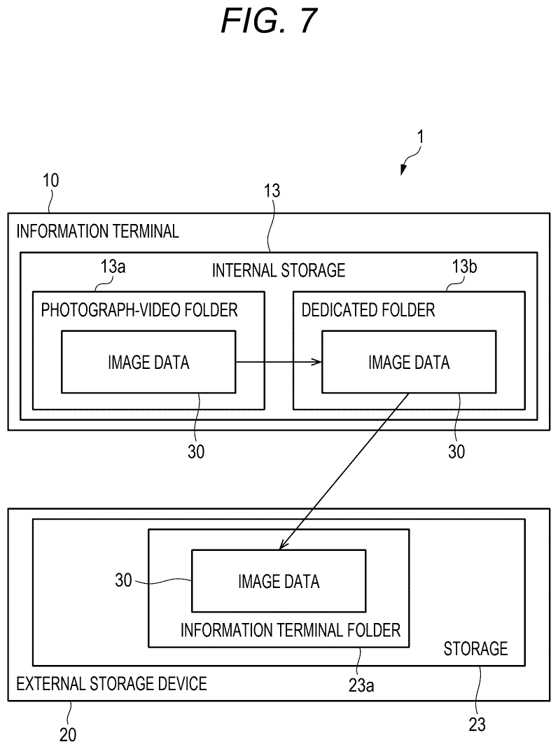

FIG. 7 is a diagram illustrating a flow of backing up the first image data in the communication system 1. The first image data is image data whose data body (backup target) is stored in the information terminal 10. The first image data is backed up from the information terminal 10 to the external storage device 20.

As illustrated in FIG. 7, the internal storage 13 of the information terminal 10 is provided with a photograph-video folder 13a for storing the first image data, and a dedicated folder 13b which is a temporary folder assigned to the backup application 18. A storage 23 of the external storage device 20 is provided with an information terminal folder 23a for backing up the first image data.

The first image data is stored as image data 30 in the photograph-video folder 13a under the management of the operating system 17. Based on the management list of the image data acquired from the operating system 17, the backup application 18 requests the first image data of one of the image data 30 stored in the photograph-video folder 13a. In response to the request, the operating system 17 sends the first image data of one of the image data 30 to the backup application 18. The backup application 18 temporarily stores the received first image data in the dedicated folder 13b as the image data 30.

Next, the backup application 18 backs up the first image data stored in the dedicated folder 13b to the information terminal folder 23a of the external storage device 20 as the image data 30. When one piece of first image data is backed up in the information terminal folder 23a, the backup application 18 registers, in the written list 60 (FIG. 6), identification information (for example, a file name and a writing date and time) of the one piece of first image data that has been successfully backed up. When one piece of first image data is backed up in the information terminal folder 23a, the backup application 18 deletes the first image data stored in the dedicated folder 13b from the dedicated folder 13b. The series of processes for backing up the first image data from the photograph-video folder 13a to the information terminal folder 23a of the external storage device 20 is repeated by the information terminal 10 for the number of pieces of first image data in the management list.

When the first image data that has been successfully backed up is registered in the written list 60 (for example, the second backup process), the backup process is repeated the number of times equal to the number of pieces of first image data in the backup list, which is a list obtained by deleting the first image data in the written list 60 from the first image data in the management list.

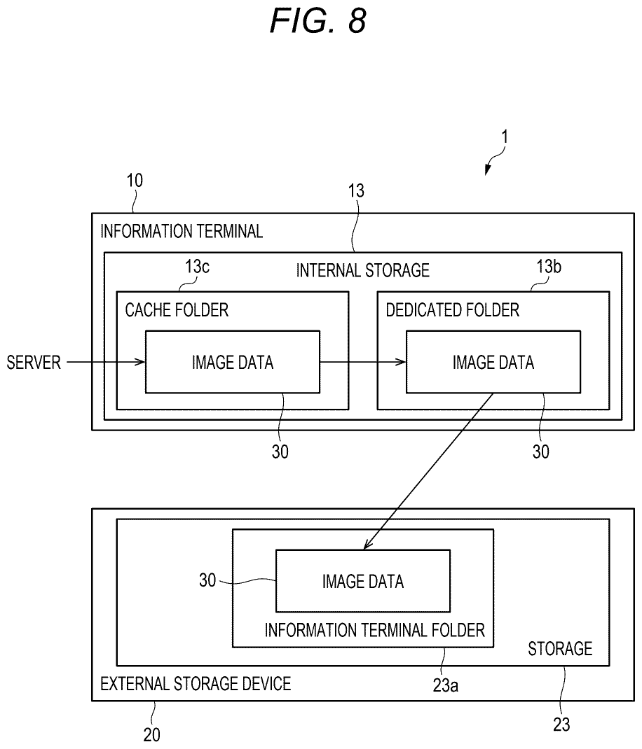

FIG. 8 is a diagram illustrating a flow of backing up the second image data in the communication system 1. The second image data is image data whose data body (backup target) is stored in the server 50. As the second image data, only a thumbnail, for example, which is a reduced version of the data body, is stored in the information terminal 10. The second image data is backed up from the server 50 to the external storage device 20.

As illustrated in FIG. 8, the internal storage 13 of the information terminal 10 is provided with a cache folder 13c for storing the second image data, and the dedicated folder 13b which is a temporary folder assigned to the backup application 18. The storage 23 of the external storage device 20 is provided with the information terminal folder 23a for backing up the second image data.

Based on the management list of the image data acquired from the operating system 17, the backup application 18 requests the second image data of one of the image data 30 stored in the cache folder 13c. In response to the request, if the second image data is not in the cache folder 13c, the operating system 17 downloads the second image data from the server 50, stores the second image data in the cache folder 13c as the image data 30, and sends the second image data to the backup application 18. Further, if the second image data is in the cache folder 13c, the operating system 17 reads the second image data from the cache folder 13c and sends the second image data to the backup application 18.

The backup application 18 temporarily stores the received second image data in the dedicated folder 13b as the image data 30. When the second image data is requested, if the second image data cannot be downloaded due to insufficient capacity of the cache folder 13c, the backup application 18 may make a request to secure the capacity of the cache folder 13c, and then request the second image data again.

Next, the backup application 18 backs up the second image data stored in the dedicated folder 13b to the information terminal folder 23a of the external storage device 20 as the image data 30. When one piece of second image data is backed up in the information terminal folder 23a, the backup application 18 registers, in the written list 60 (FIG. 6), identification information (for example, a file name and a writing date and time) of the one piece of second image data that has been successfully backed up. When one piece of second image data is backed up in the information terminal folder 23a, the backup application 18 deletes the second image data stored in the dedicated folder 13b from the dedicated folder 13b. The series of processes for backing up the second image data from the cache folder 13c to the information terminal folder 23a of the external storage device 20 is repeated by the information terminal 10 for the number of pieces of second image data in the management list.

When the second image data that has been successfully backed up is registered in the written list 60 (for example, the second backup process), the backup process is repeated the number of times equal to the number of pieces of second image data in the backup list, which is a list obtained by deleting the second image data in the written list 60 from the second image data in the management list.

In the above embodiment, the backup application 18 classifies the data into the first image data stored in the information terminal 10 and the second image data stored in the server 50, and then first backs up the first image data, and then backs up the second image data, but the present disclosure is not limited to this. For example, after the first image data and the second image data are classified by the backup application 18, the user may be able to select a file to be backed up. Specifically, the user may be allowed to select whether to back up only the first image data, only the second image data, or both the first image data and second image data. Further, after the first image data and the second image data are classified by the backup application 18, the user may be able to select an extraction condition for the file to be backed up. Specifically, the user may be allowed to select whether to back up image data in a predetermined imaging period, or a predetermined media type (video only), or the like.

If the information terminal 10 is not connected to the wireless LAN after the first image data and the second image data are classified by the backup application 18, the backup application 18 may back up only the first image data and may not back up the second image data. After the first image data and the second image data are classified, the backup application 18 may first back up the second image data and then back up the first image data. This allows the user, for example, when the user is about to go out, to give priority to backing up the second image data (cloud data) before going out (while the wireless LAN is still available).

As described above, the backup application 18 of the information terminal 10 executes the first backup process of storing the files managed by the information terminal 10 in the external storage device 20 and registering the identification information of the successfully stored files in the written list. When storing files managed by the information terminal 10 in the external storage device 20 in the second backup process executed after the first backup process, the backup application 18 stores files excluding the files registered in the written list. According to this configuration, the backup application 18 does not back up a file that has been successfully stored in the previous backup process in the next backup process, so that files to be backed up can be efficiently stored in the external storage device 20.

In the first backup process, in a case where storage of a file to the external storage device 20 fails, the backup application 18 of the information terminal 10 does not execute the storage of the file related to the failure to the external storage device 20 if the cause of the failure is continuous, and re-executes the storage of the file related to the failure to the external storage device 20 if the cause of the failure is not continuous. According to this configuration, the backup application 18 can store a file that has failed to be stored due to, for example, an accidental write error, by re-executing the backup process, so that the files to be backed up can be efficiently stored in the external storage device 20.

The backup application 18 of the information terminal 10 registers the identification information of the files successfully stored in the second backup process in the written list. According to this configuration, the backup application 18 does not create a new written list in the second backup process, but registers a file successfully stored in the second backup process in the written list taken over from the first backup process, so that the data size of the written list can be reduced.

The backup application 18 of the information terminal 10 does not register the identification information of a file that has failed to be stored in the first backup process in the written list. According to this configuration, the data size of the written list can be reduced as compared with a configuration in which a backup log is simply taken. Further, the backup application 18 executes the backup process again in the next backup process for a file that has failed to be stored due to an interruption of the backup process, so that all files to be backed up can be stored in the external storage device 20 without any omissions.

### Modifications

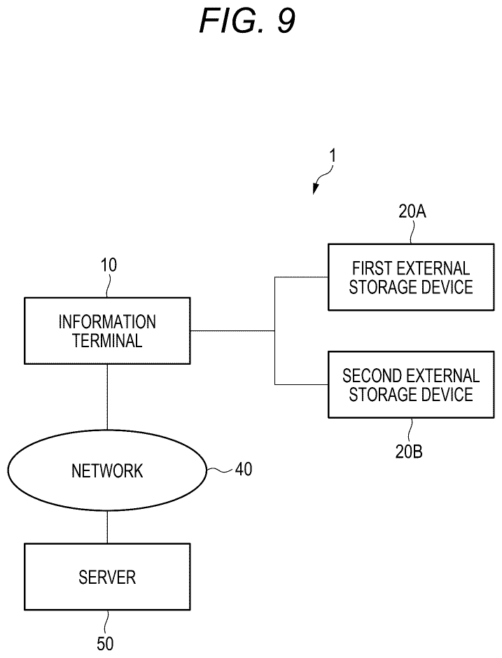

FIG. 9 is a diagram illustrating a modification of the communication system 1. As illustrated in FIG. 9, in the communication system 1, the information terminal 10 may be communicably connected to a plurality of external storage devices (in this example, a first external storage device 20A and a second external storage device 20B). For example, when the connection between the information terminal 10 and the external storage devices is wired, the first external storage device 20A and the second external storage device 20B are connected to the information terminal 10 via a hub. The first external storage device 20A is an example of the “second external storage device” of the present disclosure. The second external storage device 20B is an example of the “first external storage device” of the present disclosure.

In this configuration, the files to be backed up include a file stored in the first external storage device 20A.

In the second backup process, the backup application 18 of the information terminal 10 causes the processor 11 to execute a process of storing, in the second external storage device 20B, files other than the file registered in the first list among the files stored in the first external storage device 20A. The “file stored in the first external storage device 20A” is, for example, a file stored in the first external storage device 20A from the information terminal 10. The “file registered in the first list” is a file that has been successfully stored from the first external storage device 20A to the second external storage device 20B in the first backup process. “Storing, in the second external storage device 20B, files other than the file registered in the first list” means storing, in the second external storage device 20B, a file that has not yet been stored from the first external storage device 20A.

In the second backup process, the backup application 18 causes the processor 11 to execute a process of storing, in the second external storage device 20B, files other than the file registered in the first list and the file stored in the second external storage device 20B among the files stored in the first external storage device 20A. That is, the backup application 18 excludes not only the file registered in the first list but also the file that has already been stored in the second external storage device 20B from the files to be stored in the second external storage device 20B. For example, a file that is directly backed up from the information terminal 10 to the second external storage device 20B and has already been stored is also excluded from the files to be stored.

Further, when the backup application 18 detects a file among the files stored in the information terminal 10 that is also stored in the plurality of external storage devices 20, the backup application 18 causes the processor 11 to execute a process of notifying the user to delete the detected file from the information terminal 10. The “files stored in the information terminal 10” refer to a file stored in the information terminal 10, not in the cloud (for example, the server 50). “Detects a file that is also stored in the plurality of external storage devices 20” means, for example, detection based on a list of files backed up and stored from the information terminal 10 to the first external storage device 20A and a list of files backed up and stored from the first external storage device 20A to the second external storage device 20B. “Notifying the user to delete” refers to a notification in the form of accepting a response such as “Do you want to delete? Yes/No.” In this case, if Yes is selected, the backup application 18 deletes the file. Further, the “notifying the user to delete” may be a notification that simply suggests deleting the file by normal operation.

### Process of Backup Application 18 in Modification

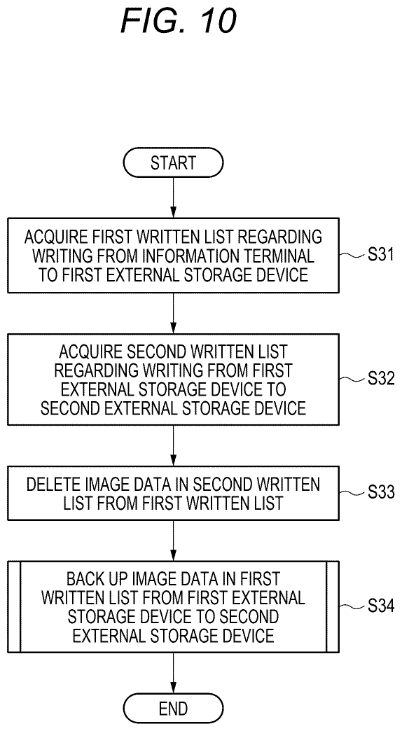

FIG. 10 is a flowchart illustrating an example of a process of the backup application 18 in the modification. The process of this flowchart is started, for example, when the user taps an icon of “save between storages” displayed on the display screen of the information terminal 10. In this example, a case will be described in which image data (an example of a file) backed up from the information terminal 10 to the first external storage device 20A is backed up from the first external storage device 20A to the second external storage device 20B.

First, the backup application 18 acquires a first written list regarding the writing of the image data backed up to the first external storage device 20A from the information terminal 10 (step S31). The first written list may be stored in the information terminal 10, for example, or in the first external storage device 20A.

Next, the backup application 18 acquires a second written list regarding writing of image data that has already been successfully backed up from the first external storage device 20A to the second external storage device 20B (step S32). The second written list is an example of the “first list” of the present disclosure. The second written list may be stored in the information terminal 10, or may be stored in the first external storage device 20A or the second external storage device 20B, for example.

The backup application 18 acquires, for example, a backup list obtained by deleting the image data in the second written list from the first written list acquired in step S31 (step S33).

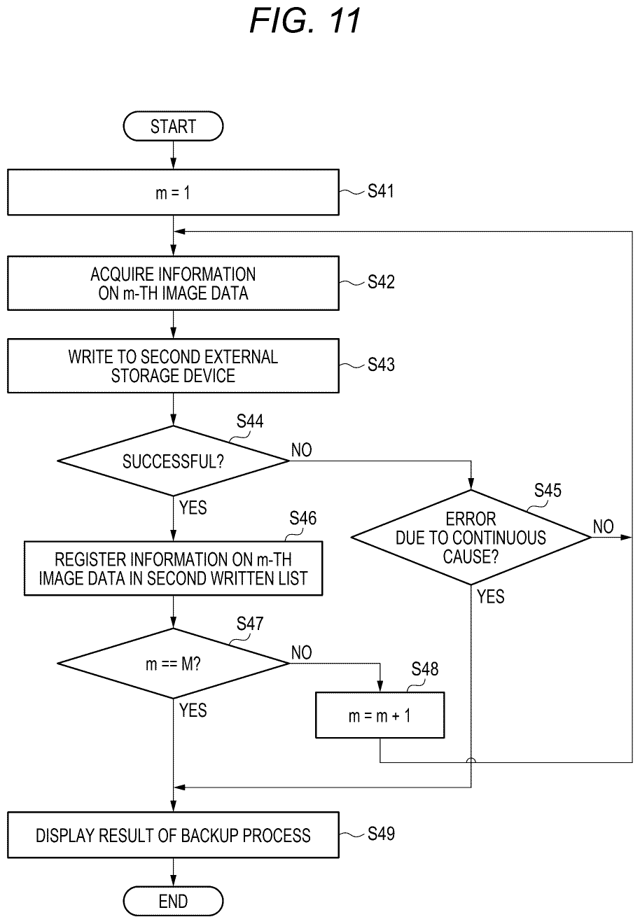

Based on the backup list acquired in step S33, the backup application 18 backs up the image data in the first written list from the first external storage device 20A to the second external storage device 20B (step S34). The backup process in step S34 will be described with reference to FIG. 11.

FIG. 11 is a flowchart illustrating the backup process in step S34 in FIG. 10.

First, the backup application 18 sets m=1 (step S41), and acquires information of m=1st image data in the backup list acquired in step S33 of FIG. 10 from the first external storage device 20A (step S42). The information about the image data includes, for example, an image data body and information related to the data.

The backup application 18 reads the information on the image data acquired in step S42 from the first external storage device 20A and writes the information to the second external storage device 20B (step S43).

The backup application 18 determines whether the image data is successfully stored in the second external storage device 20B in step S43 (step S44).

When the storage of the image data fails in step S44 (step S44: No), the backup application 18 determines whether the failure is due to a continuous cause (step S45). The continuous failure is, for example, N or more failures as described above.

If it is determined in step S45 that the failure is not continuous (step S45: No), the backup application 18 returns to step S42 and executes each process. If it is determined that the failure is not continuous, the backup application 18 may wait a predetermined time and then return to step S42. Further, if the failure is an error that does not require returning to step S42 to acquire information on the image data from the first external storage device 20A again, the backup application 18 may return to step S43 and execute each process.

If it is determined in step S45 that the failure is continuous (step S45: Yes), the backup application 18 displays the result of the backup process on the display screen of the information terminal 10 (step S49). If the cause of the failure is continuous, the backup application 18 does not store the image data related to the failure, at least not in this backup process.

On the other hand, if the image data is successfully stored in step S44 (step S44: Yes), the backup application 18 registers the information about the m=1st image data in the second written list (step S46).

Next, the backup application 18 determines whether the number (m-th) of pieces of the image data to be backed up has reached M-th (m=M?) (step S47). The M is the number of pieces of image data registered in the backup list.

If m=M is not satisfied in step S47 (step S47: No), the backup application 18 sets m=m+1 (step S48) and returns to step S42 to execute each process. If m=M in step S47 (step S47: Yes), that is, when the backup process of the image data registered in the backup list is completed, the backup application 18 displays the result of the backup process on the display screen of the information terminal 10 (step S49).

### Backup of Image Data in Modification

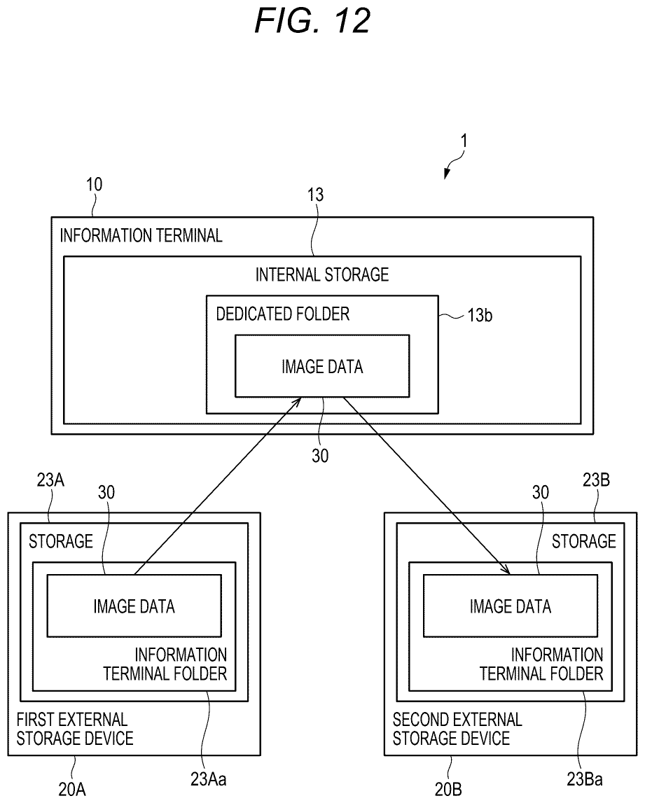

FIG. 12 is a diagram illustrating a flow of backing up image data in the communication system 1. In the present modification, the image data to be backed up is image data stored in the first external storage device 20A. The image data to be backed up is backed up from the first external storage device 20A to the second external storage device 20B.

As illustrated in FIG. 12, the internal storage 13 of the information terminal 10 is provided with the dedicated folder 13b which is a temporary folder assigned to the backup application 18. The storage 23A of the first external storage device 20A is provided with the information terminal folder 23Aa for backing up the image data. The storage 23B of the second external storage device 20B is provided with the information terminal folder 23Ba for backing up the image data.

The image data to be backed up is stored as the image data 30 in the information terminal folder 23Aa of the first external storage device 20A. The backup application 18 reads one piece of image data among the image data 30 stored in the information terminal folder 23Aa based on the first written list of the image data backed up from the information terminal 10 to the first external storage device 20A. The backup application 18 temporarily stores the read image data in the dedicated folder 13b as the image data 30.

Next, the backup application 18 backs up the image data stored in the dedicated folder 13b to the information terminal folder 23Ba of the second external storage device 20B as the image data 30. When one piece of image data is backed up in the information terminal folder 23Ba, the backup application 18 registers, in the second written list (FIG. 6), identification information (for example, a file name and a writing date and time) of the one piece of image data that has been successfully backed up. When one piece of image data is backed up in the information terminal folder 23Ba, the backup application 18 deletes the image data stored in the dedicated folder 13b from the dedicated folder 13b. A series of processes for backing up image data from the information terminal folder 23Aa of the first external storage device 20A to the information terminal folder 23Ba of the second external storage device 20B is repeated the number of times equal to the number of pieces of image data in the first written list.

When image data that has been successfully backed up is registered in the second written list (for example, the second backup process), the backup process of the image data is repeated the number of times equal to the number of pieces of image data in the backup list after the image data in the second written list is deleted from the image data in the first written list.

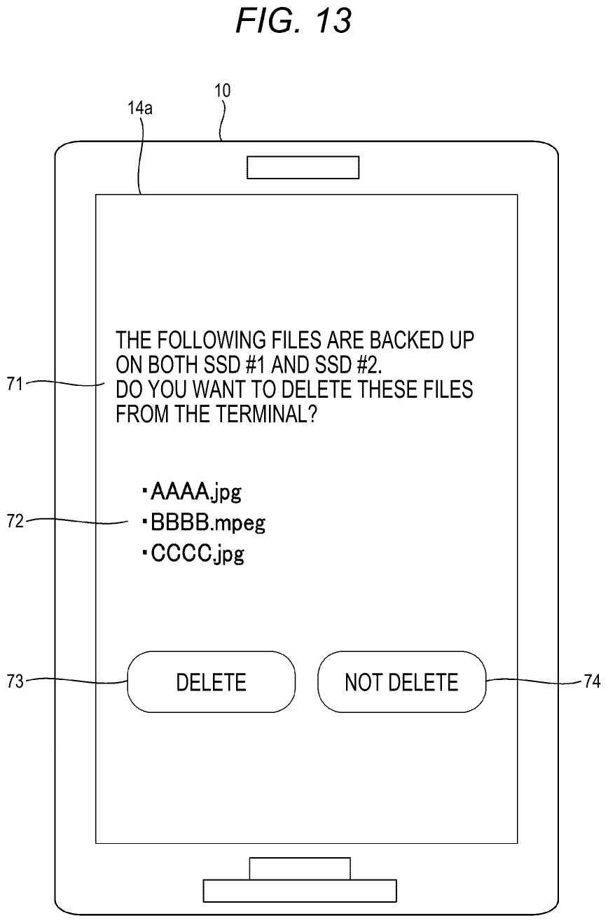

FIG. 13 is a diagram illustrating an example of a notification prompting deletion of a file. As described above, when the backup application 18 detects a file among the files stored in the information terminal 10 that is also stored in the first external storage device 20A and the second external storage device 20B, the backup application 18 notifies the user to delete the detected file from the information terminal 10.

Detection of, for example, “duplicate files” stored in both the first external storage device 20A and the second external storage device 20B is performed based on the first written list indicating image data backed up from the information terminal 10 to the first external storage device 20A, and the second written list indicating image data backed up from the first external storage device 20A to the second external storage device 20B.

If duplicate files are detected, as illustrated in FIG. 13, a touch panel 14a of the information terminal 10 displays a message 71 such as “The following files are backed up on both SSD #1 and SSD #2. Do you want to delete these files from the terminal?”, file names 72 such as “AAAA.JPG, BBBB.mpeg, CCCC.jpg”, a delete button 73 to be tapped if the files are to be deleted, and a not-delete button 74 to be tapped if the files are not to be deleted.

When the delete button 73 is tapped, the duplicate file with the displayed file name 72 is deleted from the information terminal 10. The duplicate file is deleted from the information terminal 10, but is still stored in the first external storage device 20A and the second external storage device 20B, and therefore can be restored to the information terminal 10. This notification prompting the user to delete the duplicate file is executed after the backup process in FIG. 11, for example.

As described above, the backup application 18 of the information terminal 10 in the modification executes the first backup process of acquiring the first written list indicating the files that have been successfully stored in the backup process of storing the files managed by the information terminal 10 in the first external storage device 20A, storing the files stored in the first external storage device 20A in the second external storage device 20B, and registering the identification information of the files that have been successfully stored in the second written list. When the backup application 18 stores the file stored in the first external storage device 20A in the second external storage device 20B in the second backup process executed after the first backup process, the backup application 18 stores the file based on the backup list obtained by excluding the file registered in the second written list from the files in the first written list. According to this configuration, a file that has been successfully stored in the previous backup process is not backed up in the next backup process, so that files to be backed up can be efficiently stored from the first external storage device 20A to the second external storage device 20B.

Further, when the backup application 18 of the information terminal 10 detects a file among the files stored in the information terminal 10 that is also stored in the plurality of external storage devices 20, the backup application 18 notifies the user to delete the detected file from the information terminal 10. According to this configuration, it is possible to secure a free space in the internal storage 13 of the information terminal 10.

### Control Program

A control method of the information terminal described in the above embodiments can be implemented by executing a control program prepared in advance on a computer. The control program is stored in a computer-readable storage medium and is executed by being read from the storage medium. The control program may be provided by being stored in a non-transitory computer-readable storage medium such as a flash memory, or may be provided via a network such as the Internet. The computer that executes the control program may be included in an information terminal, may be included in an electronic device capable of communicating with the information terminal, or may be included in a server device capable of communicating with the information terminal and the electronic device.

As described above, the following matters are disclosed in this specification.

A storage medium according to the present disclosure is a non-transitory computer-readable storage medium storing a control program for an information terminal. The control program causes a processor of the information terminal to execute processes including: a first backup process including storing one or more files to be backed up in an external storage device capable of communicating with the information terminal, and registering identification information of a successfully stored file in a first list; and a second backup process, which is executed after the first backup process, including storing one or more files to be backed up in the external storage device based on the first list.

In the first backup process, under a condition one file is successfully stored in the external storage device, identification information of the one file may be registered in the first list.

The first backup process may include: under a condition storage of a file to the external storage device fails, determining whether a cause of the failure is continuous; and under another condition the cause is continuous, storage of a file related to the failure in the external storage device is not executed.

The first backup process may include: under a condition storage of a file to the external storage device fails, determining whether a cause of the failure is continuous; and under another condition the cause is not continuous, storage of a file related to the failure in the external storage device is re-executed.

The control program may cause the processor of the information terminal to further execute a process of registering, in the first list, identification information of a file that is successfully stored in the second backup process.

The file to be backed up may include a file managed by the information terminal.

The second backup process may include storing, in the external storage device, a file from among the file managed by the information terminal, excluding the file registered in the first list.

The information terminal may be capable of communicating with a second external storage device different from a first external storage device that is the external storage device, and the file to be backed up may include a file stored in the second external storage device.

The second backup process may include storing, in the first external storage device, a file from among the file stored in the second external storage device, excluding the file registered in the first list.

The second backup process may include storing, in the first external storage device, a file from among the file stored in the second external storage device, excluding the file registered in the first list and the file stored in the first external storage device.

The first list may be stored in the information terminal.

The first list may be stored in the external storage device.

The control program may cause the processor of the information terminal to further execute a process in which, under a condition a file stored in a plurality of external storage devices is also detected among a file stored in the information terminal, issuing a notification to prompt a user to delete the detected file from the information terminal.

In the first backup process, identification information of a file that has failed to be stored may not be registered in the first list.

A control method according to the present disclosure includes: by a processor of the information terminal, a first backup process including storing a file to be backed up in an external storage device capable of communicating with the information terminal, and registering identification information of a successfully stored file in a first list; and a second backup process, which is executed after the first backup process, of storing a file to be backed up in the external storage device based on the first list.

A storage medium according to the present disclosure is a non-transitory computer-readable storage medium storing a control program for an information terminal. The control program causes a processor of the information terminal to execute processes including: classifying one or more files to be backed up into a file stored in the information terminal and a file stored in an information processing device capable of communicating with the information terminal; and executing a first backup process including storing the file to be backed up in an external storage device capable of communicating with the information terminal in an order based on a result of the classification.

The first backup process includes storing the file stored in the information terminal in the external storage device, and then storing the file stored in the information processing device in the external storage device.

The first backup process includes storing the file stored in the information processing device stored in the external storage device, and then storing the file stored in the information terminal in the external storage device.

The first backup process includes storing, in the external storage device, a file from among files managed by the information terminal, excluding a file registered in a list as a file successfully stored in a backup process performed before the first backup process.

The first backup process includes, under a condition one file is successfully stored in the external storage device, registering identification information of the one file in a list.

1. A non-transitory computer-readable storage medium storing a control program for causing a processor of an information terminal to execute a process, the process comprising:
a first backup process including storing one or more files to be backed up in an external storage device communicable with the information terminal, and registering identification information of a successfully stored file in a first list; and
a second backup process, which is executed after the first backup process, including storing one or more files to be backed up in the external storage device based on the first list.

2. The storage medium according to claim 1,
wherein the first backup process includes registering identification information of one file in the first list under a condition the one file is successfully stored in the external storage device.

3. The storage medium according to claim 1,
wherein the first backup process includes
under a condition storing a file in the external storage device fails, determining whether a cause of failure is continuous, and
under another condition the cause is continuous, storing the file related to the failure in the external storage device is not executed.

4. The storage medium according to claim 1,
wherein the first backup process includes
under a condition storing of a file in the external storage device fails, determining whether a cause of failure is continuous, and
under another condition the cause is not continuous, storing the file related to the failure in the external storage device is re-executed.

5. The storage medium according to claim 1,
wherein the process includes registering, in the first list, identification information of a file that is successfully stored in the second backup process.

6. The storage medium according to claim 1,
wherein the one or more files to be backed up include a file managed by the information terminal.

7. The storage medium according to claim 6,
wherein the second backup process includes storing, in the external storage device, a file from among one or more files that are managed by the information terminal and are not registered in the first list.

8. The storage medium according to claim 1,
wherein the information terminal is communicable with a second external storage device different from a first external storage device that is the external storage device, and
wherein the one or more files to be backed up include a file stored in the second external storage device.

9. The storage medium according to claim 8,
wherein the second backup process includes storing, in the first external storage device, one or more files from among one or more files that are stored in the second external storage device and are not registered in the first list.

10. The storage medium according to claim 9,
wherein the second backup process includes storing, in the first external storage device, one or more files from among the one or more files that are stored in the second external storage device, are not registered in the first list, and are not stored in the first external storage device.

11. The storage medium according to claim 1,
wherein the first list is stored in the information terminal.

12. The storage medium according to claim 1,
wherein the first list is stored in the external storage device.

13. The storage medium according to claim 1,
wherein the process includes executing a process in which, under a condition a file that is stored in a plurality of external storage devices is also stored among one or more files stored in the information terminal, issuing a notification to prompt a user to delete the detected file from the information terminal.

14. The storage medium according to claim 1,
wherein, in the first backup process, identification information of a file that has failed to be stored is not registered in the first list.

15. A control method performed by a processor of an information terminal, the control method comprising:
a first backup process including storing one or more files to be backed up in an external storage device communicable with the information terminal, and registering identification information of a successfully stored file in a first list; and
a second backup process, which is executed after the first backup process, including storing one or more files to be backed up in the external storage device based on the first list.

16. A non-transitory computer-readable storage medium storing a control program for causing a processor of an information terminal to execute a process, the process comprising:
classifying one or more files to be backed up into one or more files stored in the information terminal and one or more files stored in an information processing device communicable with the information terminal; and
executing a first backup process including storing the one or more files to be backed up in an external storage device communicable with the information terminal in an order based on a result of the classification.

17. The storage medium according to claim 16,
wherein the first backup process includes storing the one or more files stored in the information terminal in the external storage device, and then storing the one or more files stored in the information processing device in the external storage device.

18. The storage medium according to claim 16,
wherein the first backup process includes storing the one or more files stored in the information processing device in the external storage device, and then storing the one or more files stored in the information terminal in the external storage device.

19. The storage medium according to claim 16,
wherein the first backup process includes storing, in the external storage device, a file from among one or more files that are managed by the information terminal and are not registered in a list as a file successfully stored in a backup process performed before the first backup process.

20. The storage medium according to claim 16,
wherein the first backup process includes registering identification information of one file in a list under a condition the one file is successfully stored in the external storage device.
